(19) United States
(12) Patent Application Publication
(10) Pub. No.: US 2026/0264868 A1
(43) Pub. Date: Sep. 10, 2026

(54) MACHINE AND PROCESS TO REDUCE MASS FLOW LOSS IN SUPERSONIC FLOW

(71) Applicant: The Boeing Company, Arlington, VA (US)

(72) Inventors: Luis Eduardo Betances Delgado, Richmond Heights, MO (US); Matthew James Roode, Webster Groves, MO (US)

(21) Appl. No.: 19/069,844

(22) Filed: Mar. 4, 2025

(51) Int. Cl. B64D 33/02

(52) U.S. Cl. CPC B64D 33/02; B64D 2033/0226; B64D 2033/026; Y10T 137/0536

(57) ABSTRACT

A machine and process configured to control bleed-off from an airflow and/or reduce a drag of an inlet. The machine may include: a panel that may include a porous section that comprises: a length; a flow side; and a channel side; a channel that surrounds the porous section and contains a carriage adjacent to the panel, wherein the carriage comprises: a flow side; a translation component; a channel side connected to a first rigid link and to a second rigid link; a bleed gap; and a number of pressure taps; a cylinder that comprises: a forward end; an aft end; a piston connected to: a forward rod that extends out of the forward end of the cylinder; and an aft rod that extends out of the aft end of the cylinder; a number of chambers; and a bias device connected to: the aft rod; and the channel.

### BACKGROUND INFORMATION

### 1. Field

The present disclosure relates generally to controlling air flow. In particular, embodiments herein relate to controlling mass bleed-off an airflow. More specifically embodiments herein relate to controlling mass bleed-off from air flowing at supersonic speeds.

### 2. Background

Thrust output from an air-breathing engine depends upon a mass of airflow into the air-breathing engine. Due to numerous factors, controlling the mass of an airflow into the engine may be difficult to stabilize when a speed of the vehicle and/or airflow in an inlet to the engine varies across a range that includes supersonic values. When a shockwave impinges on a surface, it generates a rapid rise in static pressure, creating an adverse pressure gradient that acts against the airflow within the boundary layer, slowing down the airflow and potentially causing it to separate from the surface. Stronger shockwaves create a larger rise in the static pressure and are more likely to cause boundary layer separation.

As speed varies, a location of a shockwave along a surface may move. It may be beneficial in achieving the desired mass and flow characteristics of air entering the engine to bleed-off some of the mass of the airflow, at a location where a shockwave impinges a panel of the inlet to the engine, before the airflow enters a compressor section of the engine.

One way that shockwave induced flow separation of airflow along a surface has been reduced is to place bleed holes in the vicinity where the shockwave strikes the boundary layer. To accommodate typical flight envelopes for an air-breathing engine, an inlet to the air-breathing engine is often designed to include a bleed-off system used to bleed air off some of the airflow into the engine. However, at any specific flight condition, where a bleed air section of an inlet is in a fixed location in an inlet, an amount of air bled off from airflow into the engine though a fixed location may be greater or less than that needed to bleed-off an optimal mass from the airflow to deliver a mass of air in a state that provides the airflow needed by the engine to produce a desired amount of thrust. Currently, to ensure a mass of air is bled off the airflow in an inlet to an air-breathing engine at effective locations for an expected operating range of the engine, a size and/or number of bleed portions of the inlet are greater than they would need to be if they could be moved and/or resized in flight.

Achieving a necessary amount of mass bleed-off, without exceeding the necessary amount of mass bleed-off has been challenging to achieve. An alternate approach tried has been to install bleed air systems that might vary size, location, and/or bleed volumes, but these designs have added a complexity and resultant reliability issues as well as undesired weight to the inlet.

Therefore, it would be desirable to have a machine and process that take into account at least some of the issues discussed above, as well as other possible issues. For example, it would be desirable to have a machine and process that overcome at least a technical problem with bleeding off a precise amount of mass from airflow into an engine, at locations that may vary with a changing speed of the airflow, that is not complex and weighty compared to the inlet, as well as other problems.

### SUMMARY

Embodiments of the present disclosure provide a machine and process configured to control bleed-off from an airflow and/or reduce a drag of an inlet. The machine may include: a panel that may include a porous section that comprises: a length; a flow side; and a channel side; a channel that surrounds the porous section and contains a carriage adjacent to the panel, wherein the carriage comprises: a flow side; a translation component; a channel side connected to a first rigid link and to a second rigid link; a bleed gap; and a number of pressure taps; a cylinder that comprises: a forward end; an aft end; a piston connected to: a forward rod that extends out of the forward end of the cylinder; and an aft rod that extends out of the aft end of the cylinder; a number of chambers; and a bias device connected to: the aft rod; and the channel.

Illustrative embodiments of the present disclosure illustrate a process of controlling bleed-off from an airflow to an engine, in accordance with an illustrative embodiment. The process may begin with placing a panel, comprising a porous section comprising a flow side and a channel side, in an inlet to the engine. The process may continue with adjoining a carriage, comprising a bleed-gap, along the channel side of the porous section. The process may continue with connecting the carriage to a translation control. The process may continue with receiving, in the translation control, a number of static pressures from a number of pressure-taps in the carriage. The process may continue with using a difference in the number of static pressures for moving a portion of the translation control and the carriage. The process may continue with bleeding a mass from the airflow through the bleed-gap.

The inlet may be for a jet engine, a turbojet engine, a pulsejet, a ramjet engine, a scramjet engine, or a rotating detonation engine. The translation control may include a cylinder that may include an aft chamber, and the number of pressure-taps may include a forward pressure tap connected to the aft chamber in the cylinder. The airflow may be supersonic. The airflow may flow along a length of the porous section and form a shockwave impinging along the porous section.

The process of controlling bleed-off from an airflow to an engine may also include the translation control translating the carriage adjacent to the channel side of the porous section. The translation control comprises a cylinder that comprises a piston that is connected to: a forward rod connected to a forward rigid link connected to the carriage; and an aft rod connected to an aft rigid link connected to the carriage. In process 800, the cylinder may remain stationary relative to the panel.

Illustrative embodiments of the present disclosure illustrate a process of reducing a drag of an inlet. The process may begin with reducing a bleed-off of airflow required to produce a desired thrust from the engine via at least: tapping differential static pressures along the inlet; using a difference in the static pressures for moving a piston connected to a rod connected to a carriage comprising a bleed gap translating over a porous section of a panel of the intake; and bleeding off mass from the supersonic airflow through the bleed gap. The process of reducing a drag of an inlet may also include the inlet experiencing supersonic airflow and repeating the above process as a changing speed of the supersonic airflow changes a location along the porous section of an impingement of a shockwave.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a cross-sectional view of a machine configured to bleed-off a mass of air from and airflow along a surface, in accordance with an illustrative embodiment;

FIG. 2 is a cross-sectional view of a machine configured to bleed-off a mass of air from and airflow along a surface, in accordance with an illustrative embodiment;

FIG. 3 is a cross-sectional view of a machine configured to bleed-off a mass of air from and airflow along a surface, in accordance with an illustrative embodiment;

FIG. 4 is a cross-sectional view of a machine configured to bleed-off a mass of air from and airflow along a surface, in accordance with an illustrative embodiment;

FIG. 5 is a cross-sectional view of a machine configured to bleed-off a mass of air from and airflow along a surface, in accordance with an illustrative embodiment;

FIG. 6 is a cross-sectional side view of porous sections in a surface, in accordance with an illustrative embodiment;

FIG. 7 is a perspective view of a cross-section of a carriage for a bleed air machine, in accordance with an illustrative embodiment;

FIG. 8 is a flow chart illustration of a process of controlling bleed-off from an airflow to an engine, in accordance with an illustrative embodiment;

FIG. 9 is a flow chart illustration of a process for reducing a drag of an inlet, in accordance with an illustrative embodiment;

FIG. 10 is an illustration of an aircraft manufacturing and service process in accordance with an illustrative embodiment;

FIG. 11 is an illustration of a block diagram of an aerospace vehicle in which an illustrative embodiment may be implemented; and

FIG. 12 is an illustration of a block diagram of a product management system in accordance with an illustrative embodiment.

### DETAILED DESCRIPTION

The illustrative embodiments recognize and take into account one or more different considerations as described herein. The illustrative embodiments recognize and take into account that a technological improvement is needed to provide a machine and/or process for controlling a precise location for bleeding air from a mass of an airflow into an air-breathing engine.

The illustrative embodiments recognize and take into account that a rapid pressure rise across a shockwave thickens a boundary layer of an airflow along a surface, making it more prone to separation, especially when the pressure gradient becomes adverse. When a shockwave hits a surface, the interaction with the boundary layer of airflow along the surface can lead to significant flow separation, causing increased drag, pressure losses, and potential instability issues. Thus, where the shockwave impinges on a surface, the sudden pressure change can cause the boundary layer of airflow to separate, creating a region of unstable and/or turbulent and/or recirculating flow at the impingement point. Bleeding air off the airflow along the surface at this location can help prevent and/or reduce this separation by energizing and thinning the boundary layer and thereby maintaining the airflow more attached to the surface and improving aerodynamic performance, particularly in supersonic aerospace vehicle designs.

The illustrative embodiments recognize and take into account that current systems in an inlet of an air-breathing engine that bleed-off air have an extended length or a series of bleed sections in order to cover a range of locations for bleeding off mass from airflow into the air-breathing engine. Hence, current bleed air sections are usually larger/longer than would be needed if a bleed of an optimal size could be placed and/or moved as a shockwave moves to an optimal location, and thus bleed-off more mass from the airflow than is desired and/or produces a less than desired state of the airflow into the air-breathing engine. Thus, with a less than optimal mass of air or state of airflow entering the air-breathing engine, less than desired thrust may be produced or a higher capacity thrust engine may be designed to account for suboptimal performance issues.

The illustrative embodiments recognize and take into account that a machine and/or process that can move a location of bleed-off can be moved as a speed of the airflow changes that a smaller amount of mass of air may be bled off the airflow into the air-breathing engine at least because an oversized bleed-off section of the inlet will no longer be needed/used to ensure that mass is being bled off at a particular desired location.

The illustrative embodiments recognize and take into account that optimizing a performance of an inlet for delivering an appropriate mass of air to an air-breathing engine may send a higher proportion of the air entering the inlet into the engine and thereby allow for design and production of a smaller inlet size for a given engine and/or a higher thrust output for a given engine. One of ordinary skill in the art recognizes that these technological improvements also may provide technological improvements overall for a vehicle powered by the air-breathing engine that may include without limitation: a reduction in effective drag, a reduction in weight and associated performance benefits, an increase in thrust and associated improvements.

The illustrative embodiments recognize and take into account that with improved thrust performance for any given engine, that a further technological improvement may include choosing to design and/or manufacture the vehicle with a more efficient choice of engine for the vehicle that may provide further improvements overall that may include without limitation a reduction in drag and or a reduction in weight and associated performance benefits for the vehicle overall.

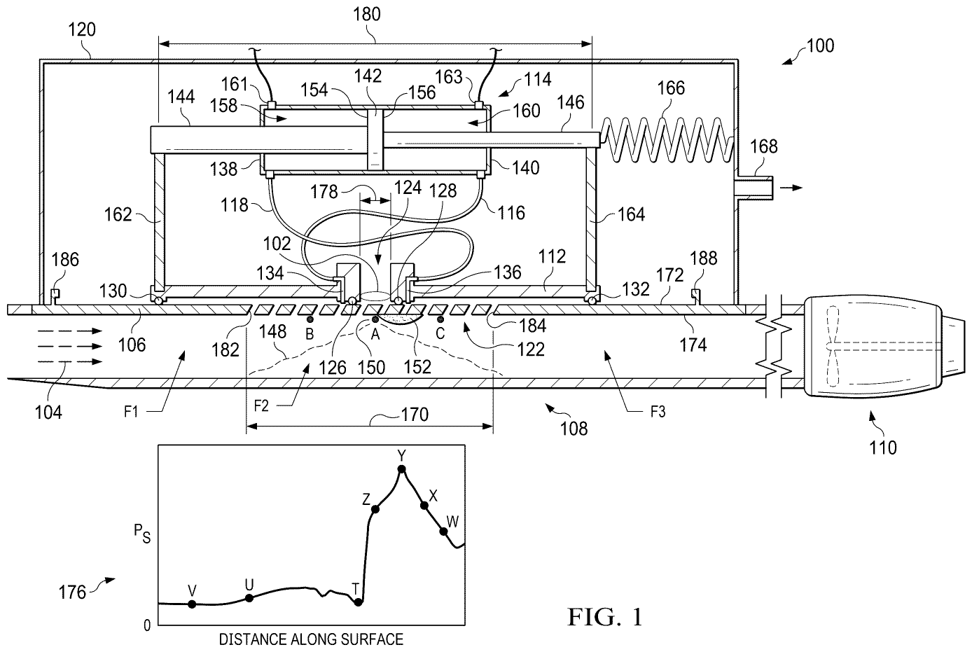

With reference now to the figures and in particular, with reference to FIG. 1, a cross-sectional view is shown of a machine configured to bleed-off a mass of air from and airflow along a surface, in accordance with an illustrative embodiment. More specifically, machine 100 is configured to bleed-off a mass 102 of air from airflow 104 along surface 106. Without limitation surface 106 may be a panel. Without limitation panel/surface 106 may be part of a wall of inlet 108 into air-breathing engine 110. Inlet 108 and engine 110 are shown in relation with machine 100, but due to illustration size limits, not shown sized proportionally to machine 100. Without limitation, air-breathing engine 110 may be a jet engine, a turbojet engine, a pulsejet, a ramjet engine, a scramjet engine, or a rotating detonation engine. Machine 100 may be called a bleed-off device or an airflow 104 control device. Machine 100 may include carriage 112, cylinder 114, forward tube 116, aft tube 118, channel 120, and porous section 122 of surface 106.

Carriage 112 may include bleed-gap 124, forward bleed-gap seal 126, aft bleed-gap seal 128, forward seal 130, aft seal 132, forward pressure-tap 134, and aft pressure-tap 136. Cylinder 114 may have forward end 138 and aft end 140. Cylinder 114 may contain piston 142 connected to forward rod 144 and aft rod 146. Cylinder 114 is fixed relative to porous section 122. Without limitation, although not shown in FIG. 1 or subsequent figures, cylinder 114 may be connected to channel 120. In other words, while forward rod 144 and aft rod 146 translate relative to porous section 122, cylinder 114 does not translate relative to porous section 122. Because cylinder 114 does not translate relative to porous section 122 but piston 142 within cylinder 114 and carriage 112 connected to piston 142 do translate relative to porous section 122, cylinder 114 and piston 142 may be considered to be a translation control in machine 100.

Also seen in FIG. 1 is shockwave 148 impinging on surface 106 at point A. Shown just down-flow from impingement point 150 is separated flow 152. Separated flow is a portion of a boundary layer of airflow 104 that separates away from surface 106. A size and/or turbulence of an amount of separated flow may be reduced and/or minimized by bleeding an appropriate mass 102 of air bled off of airflow 104 through bleed-gap 124 at impingement point 150. By not bleeding off air from airflow 104 across the entire porous section 122 as is common in current inlet 108 designs, machine 100 reduces total bleed-off from airflow 104 in inlet 108 and thus provides the technological improvement of increasing a proportion of the mass 102 captured by the inlet 108 that is actually delivered in an acceptable condition to air-breathing engine 110. Hence, a technological advantage may also be realized for design and/or manufacture, and/or retrofit, whereby because machine 100 makes the inlet 108 more efficient at delivering necessary mass 102 of air into air-breathing engine 110, a smaller inlet 108 may be used as compared to current inlets and bleed systems that are less efficient. Thus, lighter and lower drag inlets may be used as compared to current inlets and bleed systems that are less efficient for producing a given amount of thrust for a given air-breathing engine. For an engine retrofit with machine 100, the current air-breathing engine 110 may receive a greater mass 102 of airflow 104 and potentially produce more thrust than is capable with that same air-breathing engine 110 using a current style inlet 108 and bleed system that lacks machine 100.

Piston 142 may have forward area 154 and aft area 156 and divide cylinder 114 into a forward chamber 158 and an aft chamber 160. Forward area 154 may be an area of a surface 106 of piston 142 that faces forward chamber 158 of cylinder 114. Aft area 156 may be an area of a surface 106 of piston 142 that faces aft chamber 160 of cylinder 114. Forward chamber 158 may have a relief 161 that allows forward chamber 158 to avoid an over pressurization. Aft chamber 160 may have a relief 163 that allows aft chamber 160 to avoid over pressurization.

Forward rod 144 extends out of cylinder 114 and connects to forward rigid link 162 that connects to carriage 112. Aft rod 146 may extend out of cylinder 114 and connects to aft rigid link 164 that connects to carriage 112 and connects to bias device 166.

Aft tube 118 may connect aft pressure-tap 136 to forward chamber 158 of cylinder 114. Forward tube 116 may connect forward pressure-tap 134 to aft chamber 160 of cylinder 114. Channel 120 may have vent 168. Vent 168 is configured to allow mass 102 of air bled off of airflow 104 through bleed-gap 124 to flow through and not over pressurize channel 120.

Porous section 122 is a section of surface 106. Length 170 of porous section 122 may be sized by a designer and in manufacture based upon expected location of potential shockwaves throughout expected operation range for air-breathing engine 110. Without limitation, length 170 of porous section 122 may be sized by a designer and in manufacture based upon expected location of potential shockwaves for a selected portion of an expected operation range for air-breathing engine 110. At least because carriage 112 is sealed against channel side 172 of surface 106, no significant mass 102 of air bleeds off of airflow 104 across porous section 122 except through bleed-gap 124 into channel 120 where bleed-gap 124 is adjacent to porous section 122.

Precise location and size of forward pressure-tap 134 and aft pressure-tap 136 are designed to accurately transfer static pressure on flow side 174 of porous section 122 into respective chamber of cylinder 114. As shown in FIG. 1, forward pressure-tap 134 receives static pressure (with a value of Ps_{F1}) from region F1. Aft pressure tap 136 senses static pressure (with a value of Ps_{F3}) from region F3.

As shown in FIG. 1, value of Ps_{F1} may correlate to point T on chart 176. Chart 176 plots static pressure against a distance longitudinally from leading edge of inlet 108 along surface 106 and porous section 122, and Ps_{F3} may correlate to point Y on chart 176. Point Z in chart 176 represents relative static pressure at an impingement point 150 for a shockwave 148, such as without limitation shockwave 148 shown in FIG. 1. Point Z may represent static pressure (Ps) at pressure spike of a shockwave 148, whereas point T shows a lower value for Ps just prior to the impingement point 150. When bleed-gap 124 is located as desired for bleed-off that effectively energizes airflow 104 to reduce separated flow, forward pressure-tap 134 may sense Ps (static pressure) of about value at point T and pressurize aft chamber 160 of cylinder 114 to that pressure.

Likewise, length 178 of bleed-gap 124 may be based upon a desired amount of mass 102 to be bled off airflow 104 for expected operating speeds and other parameters for inlet 108 and/or air-breathing engine 110. Desired amount may provide mass 102 flow into air-breathing engine 110 that provides for a specified thrust output from air-breathing engine 110. Without limitation other parameters may include atmospheric conditions. Without limitation atmospheric conditions may include temperature and density of air entering inlet 108.

Distance 180 from forward seal 130 of carriage 112 to aft seal 132 of carriage 112 must be long enough for bleed-gap 124 to translate from start 182 of porous section 122 to stop 184 of porous section 122 in surface 106. Distance 180 from forward edge of carriage 112 to aft end 140 of carriage 112 must be long enough for forward seal 130 of carriage 112 to maintain a seal against channel 120 side of surface 106 up-flow from start 182 of porous section 122 and for aft seal 132 of carriage 112 to maintain a seal against channel 120 side of surface 106 down-flow from stop 184 of porous section 122 in surface 106.

Forward carriage-stop 186 and aft carriage-stop 188 are positioned to stop carriage 112 translation such that forward seal 130 of carriage 112 maintains a seal against channel 120 side of surface 106 up-flow from start 182 of porous section 122 and for aft seal 132 of carriage 112 to maintain a seal against channel 120 side of surface 106 down-flow from stop 184 of porous section 122 in surface 106. Forward carriage-stop 186 and aft carriage-stop 188 may be connected to channel 120 side of surface 106, or to other structural members that form channel 120.

Forward tube 116 may be formed with a size, strength, flexibility, and/or rigging to remain connected to and deliver static air pressure (Ps_{F1} with bleed-gap 124 and shockwave 148 in locations shown in FIG. 1) from along porous section 122 at forward pressure-tap 134 to aft chamber 160 of cylinder 114. Aft tube 118 may be formed with a size, strength, flexibility, and/or rigging to remain connected to and deliver static air pressure (Ps_{F3} with bleed-gap 124 and shockwave 148 in locations shown in FIG. 1) from along porous section 122 at aft pressure-tap 136 to forward chamber 158 of cylinder 114.

Hence, one of ordinary skill in the art recognizes that a static pressure from forward pressure-tap 134 acts upon aft area 156 of piston 142 to form a force to move piston 142 and connected carriage 112 along channel 120 side of surface 106 forward, away from air-breathing engine 110 while a static pressure from aft pressure-tap 136 acts upon forward area 154 of piston 142 to form a force to move piston 142 and connected carriage 112 along channel 120 side of surface 106 aft, toward air-breathing engine 110.

Hence, one of ordinary skill in the art recognizes that movement of piston 142, carriage 112, and bleed-gap 124 are controlled by design and manufacture sizes for forward area 154 and aft area 156 that provide stabilization of bleed-gap 124 at shock impingement point 150 such that static pressure at forward pressure-tap 134 acting on aft area 156 is equal to static pressure at aft pressure-tap 136 acting on forward area 154 combined with a force applied by bias device 166. Thus, for specific conditions expected for airflow 104 at selected ranges of speed along surface 106 and/or without limitation within specific geometries of inlet 108, an expected range for differentials between static pressure at forward pressure-tap 134 and static pressure at aft pressure-tap 136 will be calculable. Thus, differentials between forward area 154 of piston 142 and aft area 156 of piston 142 of any particular designed diameter may be designed by adjusting a diameter of forward rod 144 and/or aft rod 146.

Likewise, a particular bias provided by bias device 166 may be designed/selected based upon the above design parameters to include a range of movement of aft rod 146. Without limitation, a force provided by bias device 166 on aft rod 146 may be nonlinear with respect to a displacement of aft rod 146. Without limitation bias device 166 may be a spring. Without limitation, a spring constant for bias device/spring 166 may be non-linear. Without limitation a spring force provided by spring may be nonlinear with respect to a displacement of aft rod 146. Alternatively, bias device 166 may be connected instead to rod 144. Without limitation alternative configuration for bias device connect to rod 144 may be a tension spring.

In operation, airflow 104 along surface 106 may be supersonic. Chart 176 below machine 100 may be helpful to visualize what static pressures may be sensed at forward pressure-tap 134 and aft pressure tap 136 at various longitudinal distance from leading edge 190 of inlet 108 and their effect on control of position of carriage 112 and bleed-gap 124. Typically, as Mach number of airflow 104 increases, the curve of static pressure values in chart 176, including therefore, point T and peak point Y will move to the right, further into inlet 108 and closer to engine 110.

Thus, shockwave 148 may impinge surface 106 at an impingement point 150 such as without limitation impingement point 150 shown in FIG. 1 (which may be point A in a nonlimiting embodiment as shown in FIG. 1). For supersonic flow, airflow 104 in region F1 relative to impingement point 150 will have a static pressure with a value (such as without limitation point T in static pressure chart 176) that is lower than a static pressure (such as without limitation point Z in static pressure chart 176) of airflow 104 through region F2 relative to impingement point 150 and lower than a static pressure with a value (such as without limitation point Y in static pressure chart 176) in region F3 relative to impingement point 150, which is also higher than the static pressure with a value (such as without limitation point between points Y and Z in chart 176) in region F2.

As a non-limiting example, if inlet 108 is flying without limitation at 65,000 feet in a freestream of Mach 4.0, region F1 may be experiencing airflow 104 with a Mach of 3.3 producing a Ps_{F1} value of 2.0 psia (pounds per square inch absolute) forming shockwave 148 with an angle of 22 degrees from surface 106. Airflow 104 through region F2 may slow to Mach 3.0 with a Ps_{F2} of 3.3 psia. On the down-flow side of shockwave 148 Mach of airflow 104 in region F3 may drop further down to 2.7 with a Ps_{F3} rise to 5.1 psia. Thus, a pressure ratio between forward chamber 158 and aft chamber 160 may be 5.1/2.0, or 2.55. Without limitation, in a different freestream and/or another altitude, location of impingement point 150 may be in a different location, and Ps_{F1}, Ps_{F2}, Ps_{F3} values could be 2.8, 4.4, and 6.5 psia. In such a case, a pressure ratio between forward chamber 158 and aft chamber 160 may be 6.5/2.8, or 2.32. As changing pressure ratios between forward chamber 158 and aft chamber 160 act on piston 142, resulting movement of aft rod 146 are affected by, and affect force generated from bias device 166.

Alternative (not shown) to the configuration of FIG. 1, forward tube 116 and aft tube 118 could be eliminated and bias device 166 could be replaced by an actuator connected to aft rod 146 in place of bias device 166. Actuator could be driven by a controller that processes static pressure signals transmitted from sensors at forward pressure-tap 134 and aft pressure-tap 136 to the controller for actuator. The controller could be programmed to respond to differentials between static pressures at aft pressure-tap 136 and forward pressure-tap 134 to keep bleed-gap 124 centered over impingement point 150.

However, alternative configuration introduces mechanical and electronic elements that add weight and complexity beyond that shown by machine 100 shown in FIG. 1 that overcomes current bleed devices that require more mechanical and electronic elements. Greater numbers of mechanical and electronic elements in a bleed system may not only increase weight and complexity but may also reduce a resilience of the bleed system.

In contrast, machine 100 as shown in FIG. 1 provides the technological improvement of positioning bleed-gap 124 at impingement point 150 “passively” with a minimum of hardware and no electronics or software that may add complexity, cost, manufacturing and maintenance servicing and/or reliability issues, as well as added weight and associated performance penalties therefrom. In the embodiment of FIG. 1, passively may indicate without electronic control or motored actuation.

The static pressure chart 176 below machine 100 may be helpful to visualize how static pressures read at forward pressure-tap 134 and aft pressure tap 136 control position of carriage 112 and bleed-gap 124. As a nonlimiting illustration, when airflow 104 is totally subsonic and no shockwave 148 is present (ignore/eliminate shockwave 148 shown in FIG. 1), forward pressure-tap 134 may sense static pressure with a value indicated by point V on chart 176 and aft pressure-tap 136 may sense static pressure with a value indicated by point U on static pressure chart 176. Bias device 166 may be designed to have characteristics under those conditions that center piston 142 in cylinder 114 and center bleed-gap 124 over length 170 of porous section 122. In other words, when a differential between static pressure sensed at forward pressure-tap 134 and aft pressure-tap 136 is 15 percent or less, bias device 166 may provide a force that places bleed-gap 124 near a center of length 170 of porous section 122. In other words, bias device 166 is configured to reset bleed-gap 124 toward a center position when static pressures forward and aft of bleed-gap 124 are not significantly different.

Without limitation, depending upon other design conditions or operating conditions and/or flight envelopes, a designer may prefer that under such conditions carriage 112 and bleed-gap 124 settle closer toward forward carriage-stop 186 and particular characteristics of bias device 166 may be designed to apply forces that produce that outcome. Similarly, other locations may be chosen for a location of carriage 112 and bleed-gap 124 to stabilize at over porous section 122 when values of a static pressure sensed by forward pressure-tap 134 and aft pressure-tap 136 have a relatively minor pressure differential such as between values at point U and point V or T shown in chart 176.

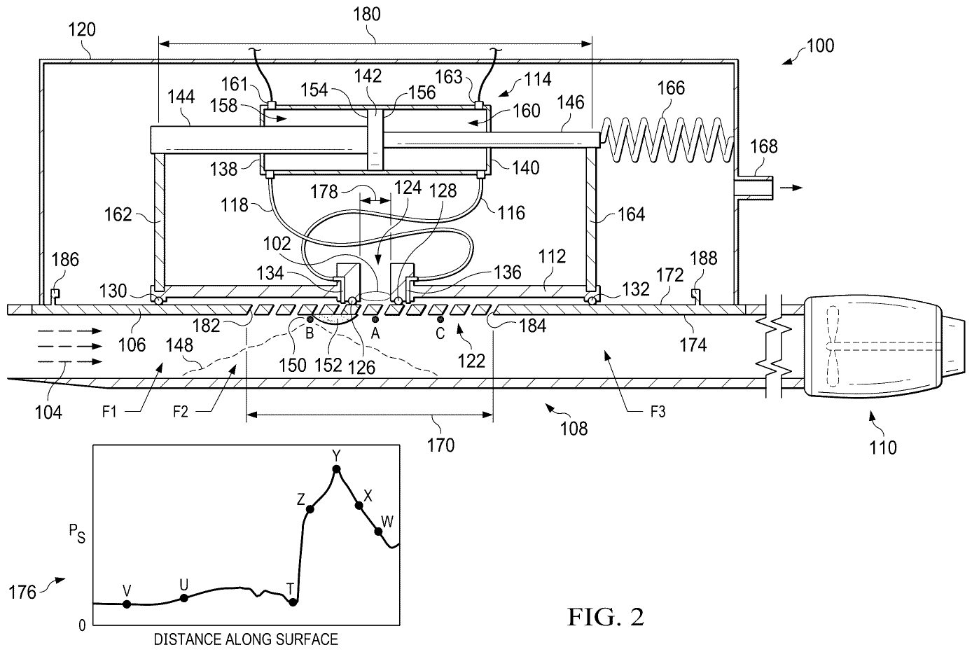

With reference now to FIG. 2, a cross-sectional view is shown of a machine configured to bleed-off a mass of air from and airflow along a surface, in accordance with an illustrative embodiment. As compared to FIG. 1, FIG. 2 shows a condition where impingement point 150 of shockwave 148 has moved up-flow along surface 106 from point A to point B. Such a movement up-flow of impingement point 150 may be the result of a change in inlet airflow 104 conditions or inlet geometry conditions. Without limitation, movement up-flow of impingement point 150 may be the result of reduction in speed of airflow 104. Separation 152 will remain near impingement point 150 and is shown in FIG. 2 as compared to FIG. 1 also moved up-flow with impingement point 150.

Machine 100 provides the technological advantage of responding to movement of shockwave 148 from point A to point B by moving bleed-gap 124 up-flow toward forward carriage-stop 186 to point B to align over impingement point 150 to draw mass 102 out of airflow 104. Hence in operation, without electronic control or mechanical actuators, machine 100 reacts to changes in static pressure along surface 106 to move carriage 112 and bleed-gap 124. A reduction of speed of airflow 104 may move shockwave 148 up-flow toward opening of inlet 108. When shockwave 148 moves up-flow, forward pressure-tap 134 and aft-pressure tap 136 now sense static pressures that have without limitation relative values Y and X respectively.

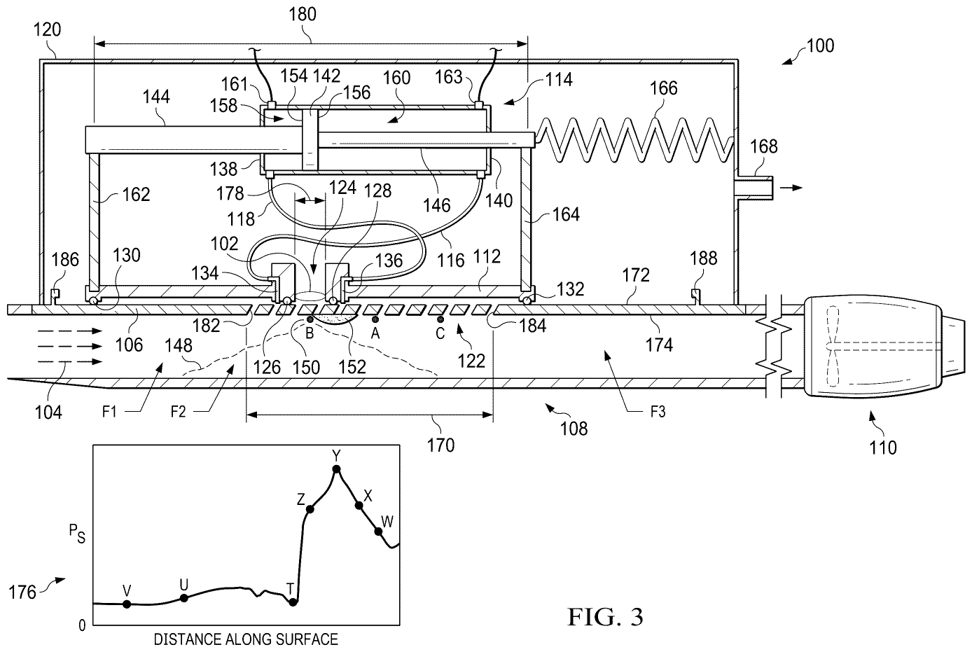

With reference now to FIG. 3, a cross-sectional view is shown of a machine configured to bleed-off a mass of air from and airflow along a surface, in accordance with an illustrative embodiment. Specifically, FIG. 3 shows carriage 112 and bleed-gap 124 positioned in reaction to shift of shockwave 148 shown in FIG. 2. When forward pressure-tap 134 and aft-pressure tap 136 sensed static pressure Y and X respectively, this causes a greater force on aft area 156 of piston 142 than the force on forward area 154 of piston 142 due to a larger surface area of aft area 156 as compared to forward area 154 and the differentials in the static pressures. As a result, piston 142 moves toward forward end 138 of cylinder 114 and thus moves carriage 112 toward forward carriage-stop 186 and up-flow until differential from static pressure in forward pressure-tap 134 and static pressure in aft pressure tap 136 acting on piston 142, in combination with force from bias device 166, stabilize and stop motion of carriage 112 with bleed-gap 124 at impingement point 150 now located at point B as shown by FIG. 3. In other words, piston 142, carriage 112, and bleed-gap 124 move toward impingement point 150 until static pressure at forward pressure-tap 134 drops from a value like point Y on chart 176 down to a value like point Z on chart 176. One of ordinary skill in the art recognizes that while actual values of Ps at any marked point in chart 176 and the specific shape of the curve shown in chart 176 may change when supersonic speed of airflow 104 changes, that relative values of static pressure remain close to the distribution shown in chart 176.

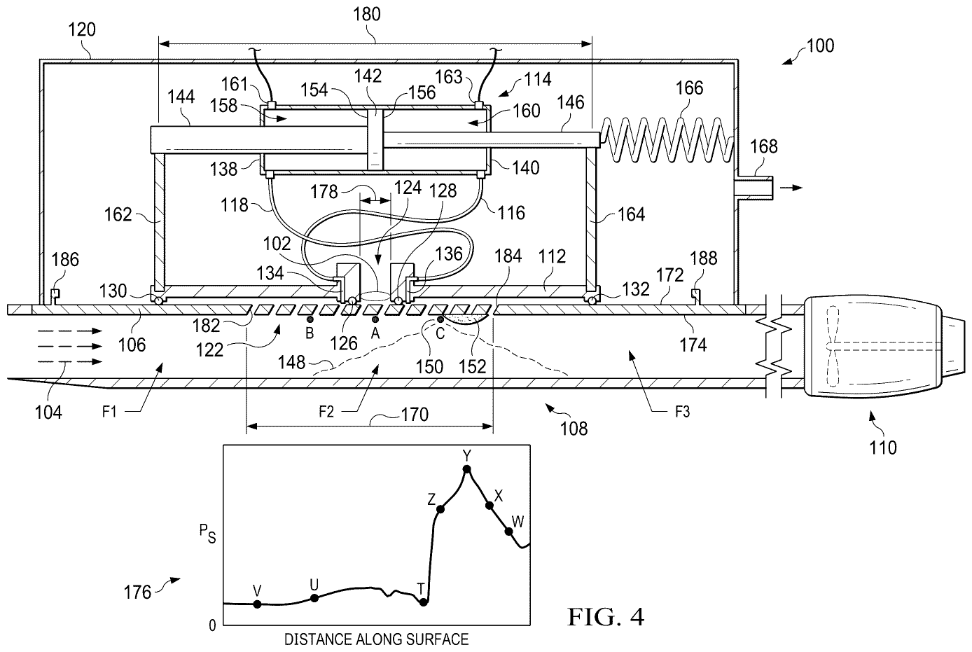

With reference now to FIG. 4, a cross-sectional view is shown of a machine configured to bleed-off a mass of air from and airflow along a surface, in accordance with an illustrative embodiment. Specifically, FIG. 4 differs from FIG. 1 by showing a movement of shockwave 148 down-flow from point A to point C. Without limitation shockwave 148 may move from point A to point C due to an increase in speed of airflow 104.

In operation, when shockwave 148 moves down-flow to point C, forward pressure-tap 134 and aft-pressure tap 136 now sense static pressures that have without limitation relative values U and V respectively. As a result of a greater values for Ps at point U and force from bias device 166, piston 142, carriage 112, and bleed-gap 124 move down-flow toward aft carriage-stop 188.

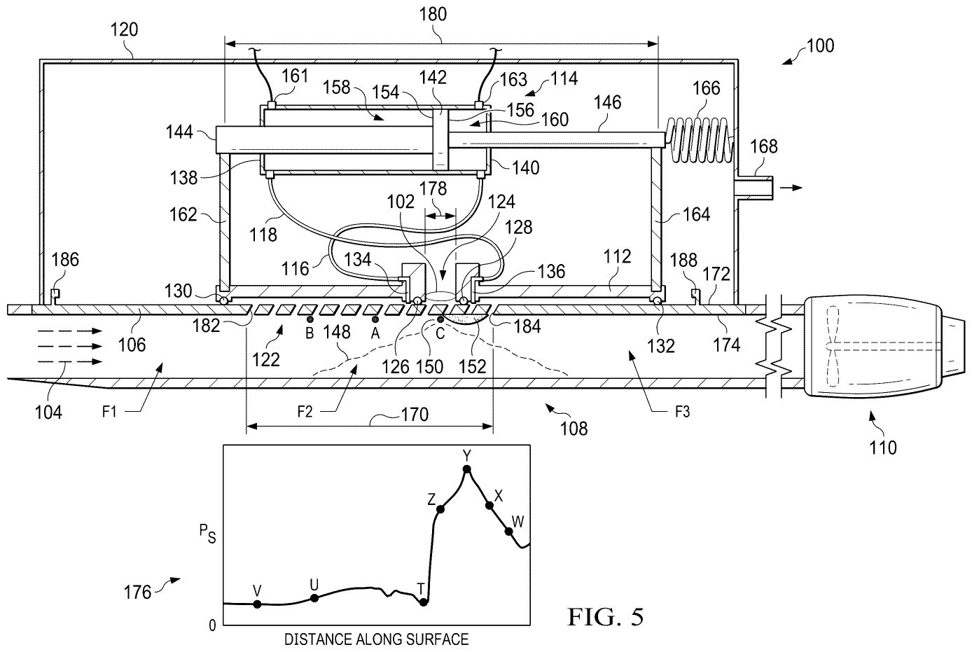

With reference now to FIG. 5, a cross-sectional view is shown of a machine configured to bleed-off a mass of air from and airflow along a surface, in accordance with an illustrative embodiment. Specifically, FIG. 5 shows location of carriage 112 and bleed-gap 124 after machine 100 responds to changes in static pressure values in inlet 108 after movement of shockwave 148 from point A to point C.

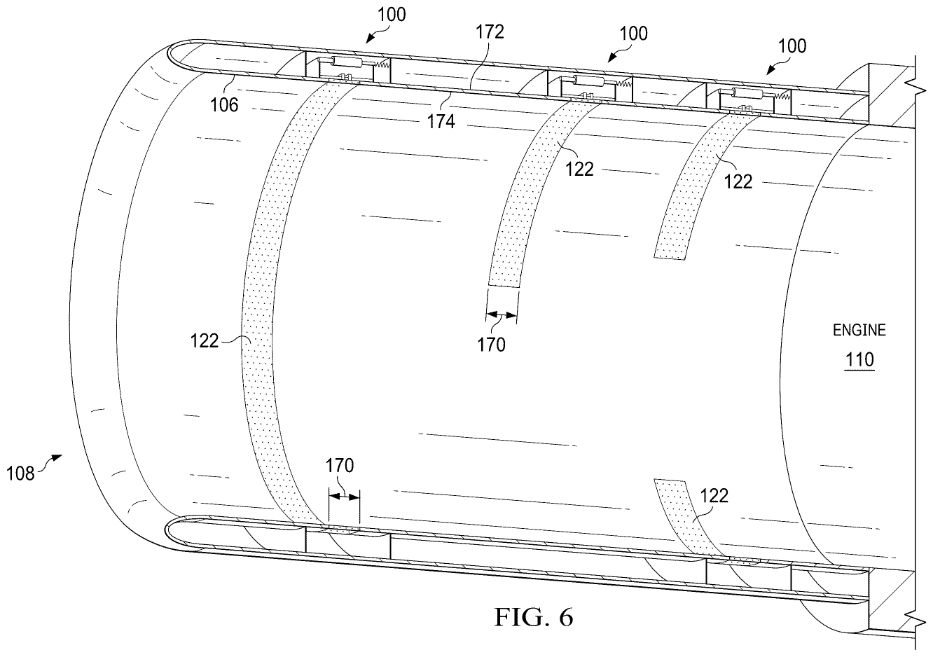

With reference now to FIG. 6, a cross-sectional side view is shown of porous sections in a surface, in accordance with an illustrative embodiment. Specifically, surface 106 in FIG. 6 may be an inner wall of inlet 108 to air-breathing engine 110. FIG. 6 is not intended to show a particular configuration or location of porous section 122 or machine 100. FIG. 6 shows potential sizes, locations, and/or combinations of sizes and locations for where porous section 122 may be incorporated into surface 106 to bleed off a designed amount of mass 102 from airflow 104 (as shown in FIGS. 1-5) into air-breathing engine 110. Design and manufacture of amount, size, and locations for porous section 122 will be designed and manufactured dependent at least upon an expected required mass 102 of air to be bled off from airflow 104 along surface 106. Required mass 102 of air to be bled off from airflow 104 along surface 106 may be designed/derived based at least upon an expected operating envelope and/or mission and/or speed range for a vehicle using air-breathing engine 110 and/or upon specific mass 102 flow requirements of specifics of air-breathing engine 110.

In instances where porous section 122 completely encircles inlet 108, machine 100 may comprise porous section 122 as a ring with carriage 112 (as shown in FIG. 1-5 and 7) as a ring (but not illustrated in a ring form), and a number of cylinder 114 with a number of aft pressure-tap 136 and forward-pressure-tap 134 located around ring to move carriage 112. Where a number of porous section 122 are located in various locations around inlet 108, each porous section 122 may have its own machine 100.

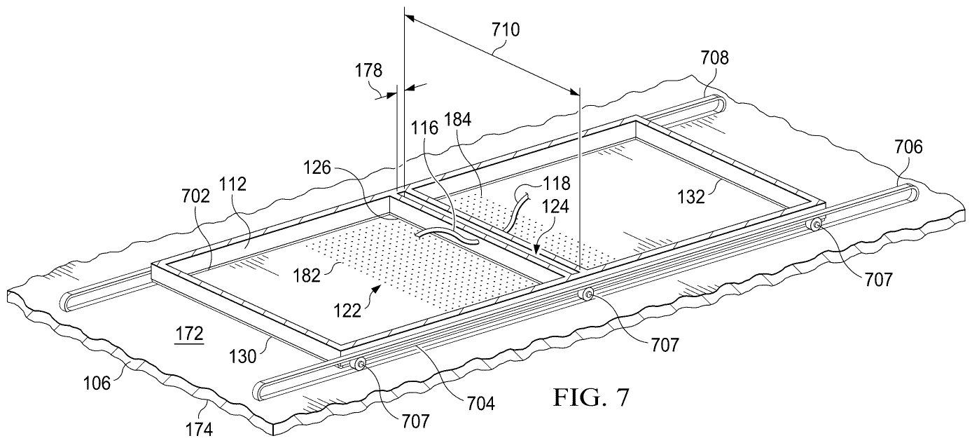

With reference now to FIG. 7, a perspective view of a cross-section of a carriage for a bleed air machine is shown in accordance with an illustrative embodiment. Specifically, carriage 112 is shown cross-sectioned below full height to show contact with channel 120 side of surface 106. Some elements from previous figures such as without limitation: channel 120, cylinder 114, and bias device 166 are not shown in FIG. 7 for clarity of viewing carriage 112 and bleed-gap 124 relationship with porous section 122 and surface 106.

Carriage 112 is held against channel 120 side of surface 106 surrounding porous section 122 such that forward seal 130 and aft seal 132 maintain contact with channel 120 side of surface 106. Similar to forward seal 130 and aft seal 132, carriage 112 also has far side seal 702 and near side seal 704 to prevent, in conjunction with forward bleed-gap seal 126 and aft bleed-gap seal 128 (as shown in FIGS. 1-5), bleed off of any air from airflow 104 through porous section 122 and carriage 112 except at/through bleed-gap 124.

As a nonlimiting embodiment, rail 706 and rail 708 located outside perimeter of porous section 122 may hold carriage 112 sealed against channel 120 side of surface 106 by engaging translation component 707 on carriage 112. Translation component 707 is a nonlimiting illustration of a part of carriage 112 that connects carriage 112 to channel 120 side of surface 106 in a manner that allows for movements of piston 142 (as shown in FIGS. 1-5) to translate carriage 112 such that bleed-gap 124 translates along length 170 of porous section 122.

Bleed-gap 124 may have an area defined by length 178 of bleed-gap 124 opening between forward bleed-gap seal 126 and aft bleed-gap seal 128 and width 710 of bleed-gap 124 across carriage 112. The area of bleed-gap 124 will affect an amount of mass 102 bled off from airflow 104 per second and may be designed and manufactured, without limitation, to be between 1 to 25 percent of a mass of inlet 108 captured airflow 104 per second. Length 178 of bleed-gap 124 partially determines precise size of area for bleed-gap 124. Area for bleed-gap 124 is designed and manufactured based upon desired air mass 102 to be delivered into air-breathing engine 110. Desired air mass 102 to be delivered into air-breathing engine 110 is determined at least by thrust desired from air-breathing engine 110 and operational envelope for air-breathing engine 110 and/or vehicle powered by air-breathing engine 110.

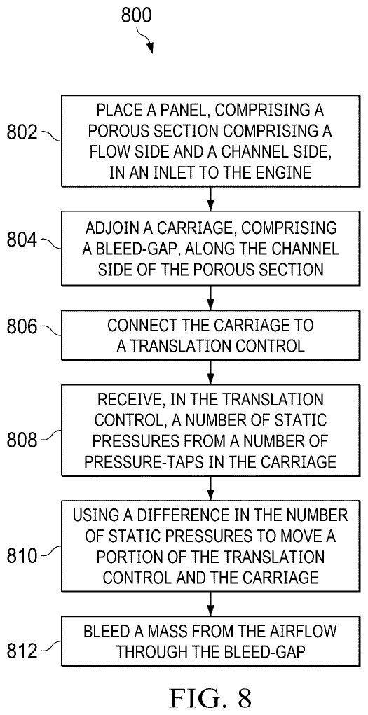

With reference now to FIG. 8, FIG. 8 is a block diagram of a flow chart for a process of controlling bleed-off from an airflow to an engine, in accordance with an illustrative embodiment. The process 800 may begin with placing a panel, comprising a porous section comprising a flow side and a channel side, in an inlet to the engine (operation 802). The process may continue with adjoining a carriage, comprising a bleed-gap, along the channel side of the porous section (operation 804). The process may continue with connecting the carriage to a translation control (operation 806). The process may continue with receiving, in the translation control, a number of static pressures from a number of pressure-taps in the carriage (operation 808). The process may continue with using a difference in the number of static pressures for moving a portion of the translation control and the carriage (operation 810). The process may continue with bleeding a mass from the airflow through the bleed-gap (operation 812).

In process 800, the inlet may be for a jet engine, a turbojet engine, a pulsejet, a ramjet engine, a scramjet engine, or a rotating detonation engine. The translation control may include a cylinder that may include an aft chamber, and the number of pressure-taps may include a forward pressure tap connected to the aft chamber in the cylinder. The airflow may be supersonic. The airflow may flow along a length of the porous section and form a shockwave impinging along the porous section.

Process 800 may also include the translation control translating the carriage adjacent to the channel side of the porous section. The translation control comprises a cylinder that comprises a piston that is connected to: a forward rod connected to a forward rigid link connected to the carriage; and an aft rod connected to an aft rigid link connected to the carriage. In process 800 the cylinder may remain stationary relative to the panel.

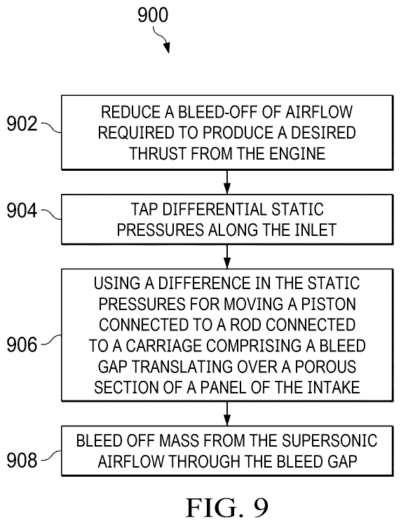

With reference now to FIG. 9, FIG. 9 is a block diagram of a flow chart for a process of reducing a drag of an inlet, process 900 may begin with reducing a bleed-off of airflow required to produce a desired thrust from the engine (operation 902) via at least: tapping differential static pressures along the inlet (operation 904); using a difference in the static pressures for moving a piston connected to a rod connected to a carriage comprising a bleed gap translating over a porous section of a panel of the intake (operation 906); and bleeding off mass from the supersonic airflow through the bleed gap (operation 908). Process 900 may also include the inlet experiencing supersonic airflow and repeating the above process as a changing speed of the supersonic airflow changes a location along the porous section of an impingement of a shockwave.

Hence, embodiments shown above provide at least the technological advantage of controlling a location and a mass of bleed-off from an airflow that is passive in the sense that it requires no electronic or computer controlled activation. Therefore, the embodiments shown above provide at least the technological advantage of being less complicated and more resilient and being lighter than current variable bleed designs. The embodiments shown also above provide the technological advantage of not bleeding-off more mass than is necessary to deliver an optimum mass with required characteristic for an airflow delivered to an engine as compared to current fixed area bleed systems for supersonic flows. Thus, the embodiments shown also above at least provide the technological advantage of a more efficient passive bleed-air system than current designs that enables using an inlet that may be smaller and lighter yet still provide required airflow for a given engine as compared to inlets required using current bleed-air systems.

While the embodiments described above are shown for airflow along a surface in an inlet to an air-breathing engine, one of ordinary skill in the art recognizes that the machine described and processes described below may be applied for airflows into inlets to other than air-breathing engines and/or for air-flows along a surface not located within an inlet. Hence, without limitation machine 100 may be located and applied to air-flow across a wing or other surface that may experience supersonic flow and shockwave 148 and/or separation 152.

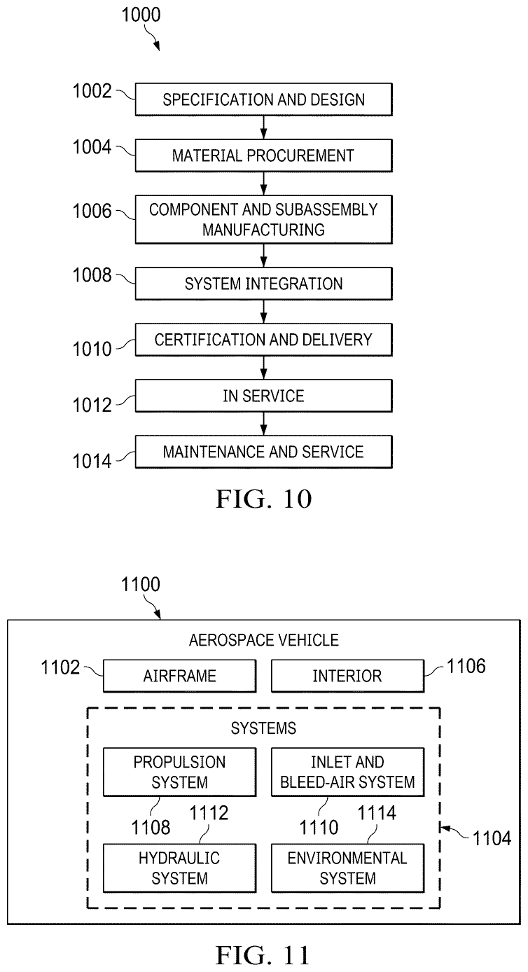

With reference now to FIG. 10, illustrative embodiments of the disclosure may be described in the context of aircraft manufacturing and service process as shown in FIG. 10 and aerospace vehicle 1100 as shown in FIG. 11. Without limitation aerospace vehicle 1100 may include a manned or an unmanned aircraft. Turning first to FIG. 10, an illustration of an aircraft manufacturing and service process is depicted in accordance with an illustrative embodiment. During pre-production, aircraft manufacturing and service process 1000 may include specification and design 1002 of aerospace vehicle 1100 in FIG. 11 and material procurement 1004.

During production, component and subassembly manufacturing 1006 and system integration 1008 of aerospace vehicle 1100 in FIG. 11 takes place. Thereafter, aerospace vehicle 1100 in FIG. 11 can go through certification and delivery 1010 in order to be placed in service 1012. While in service 1012 by a customer, aerospace vehicle 1100 in FIG. 11 is scheduled for routine maintenance and service 1014, which may include modification, reconfiguration, refurbishment, and other maintenance or service.

Each of the processes of aircraft manufacturing and service process 1000 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 11, an illustration of an aircraft is depicted in which an illustrative embodiment may be implemented. In this example, aerospace vehicle 1100 is produced by aircraft manufacturing and service process 1000 in FIG. 10 and may include airframe 1102 with plurality of systems 1104 and interior 1106. Examples of systems 1104 include one or more of propulsion system 1108, inlet and bleed-air system 1110, hydraulic system 1112, and environmental system 1114. Any number of other systems may be included. Although an aerospace example is shown, different illustrative embodiments may be applied to other industries, such as the automotive industry.

Apparatuses and processes embodied herein may be employed during at least one of the stages of aircraft manufacturing and service process 1000 in FIG. 10.

In one illustrative example, components or subassemblies produced in component and subassembly manufacturing 1006 in FIG. 10 can be fabricated or manufactured in a manner similar to components or subassemblies produced while aerospace vehicle 1100 is in service 1012 in FIG. 10. As yet another example, one or more apparatus embodiments, process embodiments, or a combination thereof can be utilized during production stages, such as component and subassembly manufacturing 1006 and system integration 1008 in FIG. 10. One or more apparatus embodiments, process embodiments, or a combination thereof may be utilized while aerospace vehicle 1100 is in service 1012, during maintenance and service 1014 in FIG. 10, or both. The use of a number of the different illustrative embodiments may substantially expedite the assembly of aerospace vehicle 1100, reduce the cost of aerospace vehicle 1100, or both expedite the assembly of aerospace vehicle 1100 and reduce the cost of aerospace vehicle 1100.

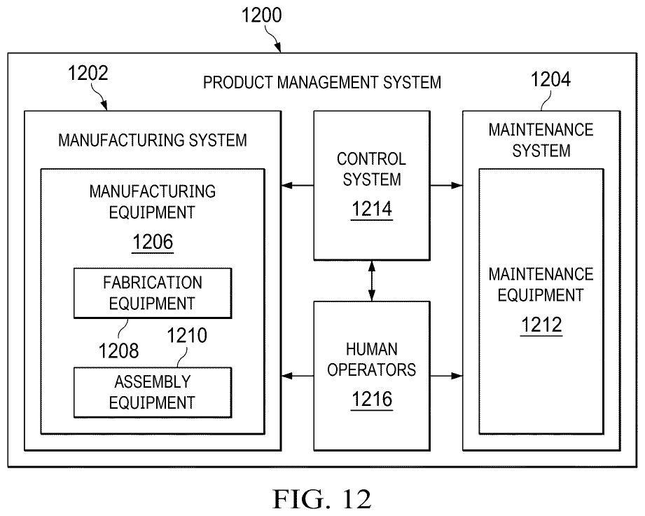

Turning now to FIG. 12, an illustration of a block diagram of a product management system is depicted in accordance with an illustrative embodiment. Product management system 1200 is a physical hardware system. In this illustrative example, product management system 1200 includes at least one of manufacturing system 1202 or maintenance system 1204.

Manufacturing system 1202 is configured to manufacture products, such as aerospace vehicle 1100 in FIG. 11 and machine 100 therein. As depicted, manufacturing system 1202 includes manufacturing equipment 1206. Manufacturing equipment 1206 includes at least one of fabrication equipment 1208 or assembly equipment 1210.

Fabrication equipment 1208 is equipment used to fabricate components for parts used to form aerospace vehicle 1100 in FIG. 11 including without limitation parts of machine 100. Fabrication equipment 1208 can be used to fabricate at least one of metal parts, composite parts, semiconductors, circuits, fasteners, ribs, skin panels, spars, antennas, or other suitable types of parts.

Assembly equipment 1210 is equipment used to assemble parts to form aerospace vehicle 1100 in FIG. 11. In particular, assembly equipment 1210 is used to assemble components and parts to form aerospace vehicle 1100 in FIG. 11. Assembly equipment 1210 also can include machines and tools. These machines and tools may be without limitation at least one of a robotic arm, a crawler, a faster installation system, a rail-based drilling system, or a robot. Assembly equipment 1210 can be used to assemble parts such as without limitation machine 100 and/or components thereof, horizontal stabilizers, wings, engines, engine housings, and other parts for aerospace vehicle 1100 in FIG. 11.

In this illustrative example, maintenance system 1204 includes maintenance equipment 1212. Maintenance equipment 1212 can include any equipment needed to perform maintenance on aerospace vehicle 1100 in FIG. 11. Maintenance equipment 1212 may include tools for performing different operations on parts such as without limitation machine 100 on aerospace vehicle 1100 in FIG. 11. These operations can include at least one of disassembling parts, refurbishing parts, inspecting parts, reworking parts, manufacturing replacement parts, or other operations for performing maintenance on aerospace vehicle 1100 in FIG. 11. These operations can be for routine maintenance, inspections, upgrades, retrofit, reconfiguration, refurbishment, or other types of maintenance operations. Hence, design of machine 100 may be for a new aerospace vehicle 1100 or to be retrofit, reconfigured, and or refurbished into inlet 108 of an existing aerospace vehicle 1100.

In the illustrative example, maintenance equipment 1212 may include ultrasonic inspection devices, x-ray imaging systems, vision systems, drills, crawlers, and other suitable devices. In some cases, maintenance equipment 1212 can include fabrication equipment 1208, assembly equipment 1210, or both to produce and assemble parts that are needed for maintenance.

Product management system 1200 also includes control system 1214. Control system 1214 is a hardware system and may also include software or other types of components. Control system 1214 is configured to control the operation of at least one of manufacturing system 1202 or maintenance system 1204. In particular, control system 1214 can control the operation of at least one of fabrication equipment 1208, assembly equipment 1210, or maintenance equipment 1212.

The hardware in control system 1214 can be implemented using hardware that may include computers, circuits, networks, and other types of equipment. The control may take the form of direct control of manufacturing equipment 1206. For example, robots, computer-controlled machines, and other equipment can be controlled by control system 1214. In other illustrative examples, control system 1214 can manage operations performed by human operators 1216 in manufacturing or performing maintenance on aerospace vehicle 1100. For example, control system 1214 can assign tasks, provide instructions, display models, or perform other operations to manage operations performed by human operators 1216. In these illustrative examples, control system 1214 manages at least one of the manufacturing or maintenance of aerospace vehicle 1100 in FIG. 11 to place machine 100 into inlet 108 for aerospace vehicle 1100. The fuel protection system can be implemented in fuel tanks during manufacturing fuel tanks for adding fuel tanks during maintenance to aerospace vehicle 1100.

In the different illustrative examples, human operators 1216 can operate or interact with at least one of manufacturing equipment 1206, maintenance equipment 1212, or control system 1214. This interaction can occur to manufacture aerospace vehicle 1100 in FIG. 11.

Of course, product management system 1200 may be configured to manage other products other than aerospace vehicle 1100 in FIG. 11. Although product management system 1200 has been described with respect to manufacturing in the aerospace industry, product management system 1200 can be configured to manage products for other industries. For example, product management system 1200 can be configured to manufacture products without limitation for the marine industry and/or automotive industry as well as any other suitable industries.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to clearly explain the principles of the embodiments, the practical application, and to enable others of ordinary skill in the art to understand the disclosure for various embodiments with various modifications as are suited to the particular use contemplated.

The flowcharts and block diagrams in the different depicted embodiments illustrate the architecture, functionality, and operation of some possible implementations of apparatuses and processes in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware can, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

1. A machine that comprises:
a panel that comprises a porous section that comprises:
a length;
a flow side; and
a channel side;
a channel that surrounds the porous section and contains a carriage adjacent to the panel, wherein the carriage comprises:
a flow side;
a translation component;
a channel side connected to a first rigid link and to a second rigid link;
a bleed gap; and
a number of pressure taps;
a cylinder that comprises:
a forward end;
an aft end;
a piston connected to:
a forward rod that extends out of the forward end of the cylinder; and
an aft rod that extends out of the aft end of the cylinder;
a number of chambers; and
a bias device connected to:
the aft rod; and
the channel.

2. The machine of claim 1, wherein the number of pressure taps comprises a forward pressure-tap located and configured to access a static pressure on the flow side of the carriage and up-flow from the bleed-gap.

3. The machine of claim 2, wherein the number of pressure taps comprises an aft pressure-tap located and configured to access a static pressure on the flow side of the carriage and down-flow from the bleed-gap.

4. The machine of claim 3, wherein the bias device is configured to place the bleed-gap at a center of the length of the porous section with a static pressure value differential between the forward pressure-tap and the aft pressure-tap being less than 15 percent.

5. The machine of claim 2, wherein the number of chambers comprises an aft chamber and the forward pressure tap is connected into the aft chamber.

6. The machine of claim 3, wherein the number of chambers comprises a forward chamber and the aft pressure-tap is connected into the forward chamber.

7. The machine of claim 1, wherein the bias device is a spring.

8. The machine of claim 1, wherein the carriage comprises a seal against the channel side of the panel.

9. The machine of claim 1, wherein the cylinder is fixed relative to the porous section, and the carriage is configured to translate along the panel responsive to a movement of the piston within the cylinder.

10. The machine of claim 1, wherein the bias is configured to place the bleed gap at a center of the length of the porous section when airflow across the panel remains subsonic.

11. A process of controlling bleed-off from an airflow to an air-breathing engine, the process comprising:
placing a panel, comprising a porous section comprising a flow side and a channel side, in an inlet to the engine;
adjoining a carriage, comprising a bleed-gap, along the channel side of the porous section;
connecting the carriage to a translation control;
receiving, in the translation control, a number of static pressures from a number of pressure-taps in the carriage;
using a difference in the number of static pressures for moving a portion of the translation control and the carriage; and
bleeding a mass from the airflow through the bleed-gap.

12. The process of claim 11, wherein the air-breathing engine is one of: a jet engine, a turbojet engine, a pulsejet, a ramjet engine, a scramjet engine, or a rotating detonation engine.

13. The process of claim 11, wherein the translation control comprises a cylinder that comprises an aft chamber, and the number of pressure-taps comprises a forward pressure tap connected to the aft chamber in the cylinder.

14. The process of claim 11, wherein the airflow flows along a length of the porous section and forms a shockwave impinging along the porous section.

15. The process of claim 11, further comprising the translation control translating the carriage adjacent to the channel side of the porous section.

16. The process of claim 11, wherein the airflow is supersonic.

17. The process of claim 11, wherein the translation control comprises a cylinder that comprises a piston that is connected to:
a forward rod connected to a forward rigid link connected to the carriage; and
an aft rod connected to an aft rigid link connected to the carriage.

18. The process of claim 17, further comprising the cylinder remaining stationary relative to the panel.

19. A process of reducing a drag of an inlet, the process comprising:
reducing a bleed-off of supersonic airflow required to produce a desired thrust from an engine;
tapping differential static pressures along the inlet;
using a difference in the static pressures for moving a piston connected to a rod connected to a carriage comprising a bleed gap translating over a porous section of a panel of the inlet; and
bleeding off mass from the supersonic airflow through the bleed gap.

20. The process of claim 19, further comprising:
the inlet experiencing supersonic airflow; and
repeating the above process as a changing speed of the supersonic airflow changes a location along the porous section of an impingement of a shockwave.
